(19) United States
(12) Patent Application Publication
(10) Pub. No.: US 2021/0276092 A1
(43) Pub. Date: Sep. 9, 2021

(54) METHOD OF HEAT TREATING A CEMENTED CARBIDE MATERIAL

(71) Applicant: ELEMENT SIX GMBH, BURGHAUN (DE)

(72) Inventors: IGOR YURIEVICH KONYASHIN, BURGHAUN (DE); HAUKE HINNERS, BURGHAUN (DE); BERND HEINRICH RIES, BURGHAUN (DE)

(73) Assignee: ELEMENT SIX GMBH, BURGHAUN (DE)

(21) Appl. No.: 17/260,706

(22) PCT Filed: Aug. 15, 2019
(86) PCT No.: PCT/EP2019/071914

§ 371 Date: Jan. 15, 2021

(30) Foreign Application Priority Data
Aug. 16, 2018 (GB) 1813391.8

(51) Int. Cl. B22F 7/08; B22F 5/00; B22F 3/24; C23C 4/10; C23C 4/134; C22C 29/08; B23K 9/04

(52) U.S. Cl. CPC B22F 7/08; B22F 5/00; B22F 3/24; C23C 4/10; C23C 4/134; E21C 35/1835; B23K 9/042; B22F 2005/001; B22F 2003/248; B22F 2302/10; C22C 29/08

(57) ABSTRACT

This disclosure relates to a method of producing a tool comprising a substrate and a hard-face coating metallurgically bonded to the substrate. The method comprises the steps of: providing a steel substrate; providing a composition of fully sintered granulate grains; and then applying the fully sintered granulate grains onto the substrate. The resultant cemented carbide material on the steel substrate comprises a specific composition and includes a metastable phase having a nanohardness of at least 12 GPa and a Palmqvist fracture toughness of below 7 MPa m½. The method includes heat-treating the hard-face coating to at least partially decompose the metastable phase, to increase the Palmqvist fracture toughness.

### FIELD OF THE INVENTION

This disclosure relates to cemented carbide materials and methods of heat-treating cemented carbide materials.

### BACKGROUND

Steel wear affects a huge variety of industries and has a severe effect on tool life. When subjected to harder and more wear resistant materials, a steel part can be subject to steel wash and premature failure.

Hard facings are commonly known within the wear industry to prolong the life expectancy of steel parts. The hard facing is metallurgically bonded to the steel part and creates a wear protection for the steel part. There are many different techniques that may be used to apply a hard facing to a steel substrate, including welding, brazing, spraying and so on. Plasma-transferred-arc welding (PTA) and laser cladding are widely used welding methods to metallurgically fuse a hard facing to a steel part. Most of the welding methods described above create a melting pool in which a precursor material and the steel are molten. The induced heat in this process can result in local degradation of the steel base. Wherever uniform steel properties are required, a subsequent heat-treatment of the steel is used. Different grades of steel typically have a narrow band of temperatures for hardening. For example, U.S. Pat. No. 4,325,758 describes that a high chromium steel requires a temperature of between 837 and 871° C. for hardening. Different compositions of steel can lead to very different hardening temperatures. The applied hard facing must also withstand the same hardening conditions as the substrate steel.

Cemented carbide material comprises particles of metal carbide, such as tungsten carbide (WC) or titanium carbide (TiC), dispersed within a binder material comprising a metal such as cobalt (Co), nickel (Ni) or metal alloy. The binder phase may be said to cement the carbide particles together as a sintered compact. Cemented carbides have a relatively high fracture toughness and hardness, and so are suitable to use as a hard facing. WO 2010/029522 describes a hard facing comprising a cemented carbide material having at least 13 volume % carbide grains, Cr, Si, C and a metal binder phase Me (Co, Fe, Ni). The hard facing has a weight loss of 80 mg when subjected to ASTM-G65-04 procedure A.

### SUMMARY

There is a need to provide a cemented carbide material, particularly for use as a hard facing, with improved wear behaviour and the ability to maintain or improve its physical properties at different hardening temperatures. As the range of hardening temperatures for specific compositions of steel is narrow, the hard facing must also not be affected by the hardening temperature.

According to a first aspect, there is provided a method of producing a tool comprising a substrate and a hard-face coating metallurgically bonded to the substrate. The method comprises the steps of providing a substrate, providing a composition of fully sintered granulate grains, and applying the fully sintered granulate grains onto the substrate. Once applied to the substrate, the resultant cemented carbide material comprises at least 0.1 wt. % Si, at least 5 wt. % Cr, less than 5 wt. % Mn, less than 10 wt. % Mo, at least 30 wt. % W, and the balance of the cemented carbide material comprising C and an iron group metal, M, M being selected from any of Co, Fe, Ni or an alloy thereof. The cemented carbide material further comprises inclusions of a metastable phase, the metastable phase comprising M, Cr, Si, W, and C and having a nanohardness of at least 12 GPa and a Palmqvist fracture toughness of below 7 MPa m^{1/2}. The method further comprises heat-treating the cemented carbide material at a temperature of at least 700° C. to achieve at least partial decomposition of the metastable phase, thereby producing a tool with a substrate and a hard-face coating metallurgically bonded to the substrate.

Depending on geometry and dimensions of cemented carbide material, the heat treating of the cemented carbide material may be performed at a temperature in the range of 700° C. to 860° C. for at least 30 minutes, or at a temperature in the range of 860° C. to 1100° C. for no more than 30 minutes. However, it will be appreciated that, for example, a large piece of cemented carbide material may be heat treated at a maximum temperature above 860° C. for longer than 30 minutes where appropriate.

As an option, the method comprises performing a second heat treatment at temperature in the range of 300° C. to 700° C. for between 10 and 360 minutes.

As a further option, the method may require performing at least one further second heat treatment.

The method optionally comprises quenching the heat treated cemented carbide material in any of water, oil, air, nitrogen, helium or a polymeric solution.

As an option, the method further comprises cooling the cemented carbide material using at least one predetermined cooling rate.

The method optionally further comprises forming a carbide precipitate in a binder phase which is due to the at least partial decomposition of the metastable phase.

As a further option, the carbide precipitate comprises any of M₂₃C₆, M₇C₃, M₃C₂, M₁₂C, M₆C, M₄C or M₃C₂. The carbide precipitate optionally has an average particle size selected from any of no more than 200 nm, and no more than 100 nm. The dimensions of the precipitate will vary in size due to the actual temperature and the holding time of the heat treatment as well as used depositional parameters of the cladding.

As an option, the method comprises forming any of Fe₃W₂ particles, FeSi particles, Cr₅Si₃ particles, and SiC particles during the heat treatment.

The method optionally comprises forming a heat treated cemented carbide article having a Vickers hardness selected from any of at least 800 HV10, at least 900 HV10 and at least 1000 HV10.

The method optionally further comprises forming nano-precipitates of mixed (Cr, M)₂₃C₆.

As an option, the method comprises forming nano-precipitates of at least one phase of the W—Fe—C system.

The method optionally further comprises forming a nano-structured Fe-based binder matrix with a ferritic, austenitic or martensitic structure having mean grain size selected from any of below 50 nm, below 30 nm and below 20 nm.

As an option, the method comprises, prior to heat treating the cemented carbide material, forming the cemented carbide material in a high temperature plasma spraying operation.

The metastable phase optionally comprises 50 to 70 wt. % M, 5 to 15 wt. % Cr, less than 10 wt. % Si, 10 to 40 wt. % W and 1 to 5 wt. % C.

The metastable phase optionally comprises 55 to 65 wt. % M, 5 to 15 wt. % Cr, less than 7 wt. % Si, 15 to 30 wt. % W and 2 to 4 wt. % C.

The metastable phase optionally comprises 50 to 70 wt. % M, 5 to 15 wt. % Cr, less than 10 wt. % Si, 15 to 30 wt. % W, 2 to 4 wt. % C, less than 5 wt. % Mn, and less than 10 wt. % Mo.

As an option, the metastable phase has a cubic lattice structure.

As an alternative option, the metastable phase has a hexagonal lattice structure.

As a further alternative, the metastable phase has a tetragonal lattice structure. The space group may be P4 and the cell parameters may be a=10.12 angstrom and c=9.5 angstrom. These features are identifiable and measurable using XRD technique.

The metastable phase is optionally present as a plurality of elongate or plate-like structures having a mean length of at least 1 μm.

According to a second aspect, there is provided a tool obtained by the method in accordance with the first aspect, wherein the hard-face coating has a hardness of at least 12 GPa and a Palmqvist facture toughness of at least 11 MPa m^{1/2}.

### BRIEF DESCRIPTION OF THE DRAWINGS

Non-limiting example arrangements to illustrate the present disclosure are described with reference to the accompanying drawings, in which:

FIG. 1 is a flow diagram showing exemplary steps;

FIG. 2 is a graph of temperature against time for an exemplary cooling regime

FIG. 3 is a micrograph showing an exemplary microstructure of a cemented carbide hard facing without heat treatment;

FIG. 4 is a micrograph showing an exemplary microstructure of a cemented carbide hard facing after heat treatment; and

FIG. 5 is a micrograph showing an exemplary microstructure of a cemented carbide hard facing binder phase after heat treatment.

### DETAILED DESCRIPTION

Some cemented carbide materials are designed so that the binder has as low melting point, enabling them to be formed as granules and then coated onto a substrate by a high temperature plasma spraying operation. An example of such a cemented carbide includes at least 0.1 wt. % Si, at least 5 wt. % Cr, less than 5 wt. % Mn, less than 10 wt. % Mo, at least 30 wt. % W, and the balance of the cemented carbide material comprising C and an iron group metal, M, M being selected from any of Co, Fe, Ni or an alloy thereof.

It has been found that some of these cemented carbide materials further comprising inclusions of a metastable phase that comprises M, Cr, Si, W, and C. This metastable phase can be brittle and detrimental to the properties of the cemented carbide material. It has now been found that heat treatment of the cemented carbide material can cause decomposition of the metastable phase. This has two benefits; the removal of a brittle phase that is otherwise detrimental to the properties of the cemented carbide material, and the decomposition products can form nano-scale carbides that improve the toughness of the cemented carbide material. Note that heat treatment can be applied in any suitable way, such as by placing the cemented carbide material in an oven or applying heat directly (for example with a laser). Note also that heat treatment can, if required, be carried out in a controlled atmosphere.

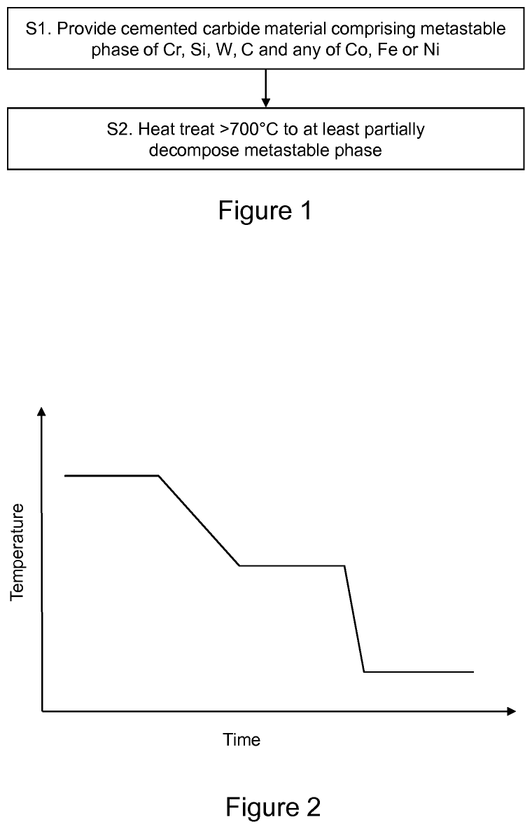

FIG. 1 is a flow diagram in which exemplary steps are described. The following numbering corresponds to that of FIG. 1:

S1. A cemented carbide material is provided. The cemented carbide material comprises at least 0.1 wt. % Si, at least 5 wt. % Cr, less than 5 wt. % Mn, less than 10 wt. % Mo, at least 30 wt. % W, and the balance of the cemented carbide material comprises C and an iron group metal, M. M is selected from any of Co, Fe, Ni or an alloy thereof, the cemented carbide material further comprises inclusions of the metastable phase. The metastable phase comprises M, Cr, Si, W, and C, and has a nanohardness of at least 12 GPa and a Palmqvist fracture toughness of below 7 MPa m^{1/2}.

S2. The provided cemented carbide material is then heat treated at a temperature of at least 700° C. to at least partial decompose metastable phase. The heat treatment may have a maximum temperature in the range of 700 ° C. to 860° C. for at least 30 minutes. Alternatively, the heat treatment may have a maximum temperature in the range of 860° C. to 1100° C. for no more than 30 minutes. However, these are guidelines only, as the precise times and temperatures are dependent upon the geometry and dimensions of the cemented carbide material subjected to the heat treatment. For larger pieces of cemented carbide material, it may be appropriate to use a heat treatment with a maximum temperature greater than 860° C. for a time longer than 30 minutes.

The cooling rate during heat treatment can influence the decomposition products that form. Cooling rates and steps are therefore predetermined to affect the final cemented carbide material. Cooling may be performed in a single step from the heat treatment temperature to room temperature, or it may require multiple steps, as shown in FIG. 2, in which a first cooling rate is applied from the heat treatment temperature to a second, lower heat treatment temperature, and a second cooling rate is applied from the second temperature to room temperature.

It has also been found that the way the cooling is applied can affect the final microstructure because of the cooling rate and the control of the cooling rate. Cooling may be performed by quenching, for example in any of water, oil, air, nitrogen, helium or a polymeric solution. When using a liquid such as water or oil as the quenching media, the liquid can start to boil around the cemented carbide. This transformation from liquid to gas gives a variable and less predictable cooling rate, and so for some types of cemented carbide material it is preferred to quench in a gas such as helium to ensure a constant cooling rate.

There are now described some examples of cemented carbide materials and the heat treatments applied.

### EXAMPLE 1

A 5 kg batch of powder comprising 73.5 wt. % WC powder with a mean diameter of about 0.8 μm, 15 wt. % Fe powder, 10 wt. % Cr₃C₂ powder and 1.5 wt. % Si powder was milled for about 24 hours in an attritor mill in a medium of hexane with 30 kg of WC balls.

After milling, the resultant slurry was dried for 1 hour at 80° C. and the dried powder was screened by sieving to eliminate agglomerates and milling media. The resulting powder was pre-pressed to form blocks with a density that gave sufficient mechanical strength for the subsequent manufacturing processes of forming granules.

The blocks were then broken up by an Allgaiersieve to 500 μm and sieved to 260 μm. An ultra-sonic sieve was then used to screen out a fine fraction below 75 μm of the granulate grains, leaving a fraction between 75 μm and 260 μm. The resulting granulate grains were pre-sintered at 1200° C. for one hour. The pre-sintered granulate grains were screened to 400 μm and 60 μm. The granulate fraction was then fully sintered at 1300° C. for 1.5 hours. Finally, the fully sintered granulate grains were screened to 260 μm and 60 μm. Iron powder with the same grain fraction was then added to achieve 30 wt. % total iron content.

The resulting mixture was applied to a St52 steel substrate by plasma-transferred-arc welding. The welding process used 140A of transfer current, 30 grams per minute powder feed and a cladding speed of 44 millimetres per minute. The hardness of the resultant cemented carbide hard facing varied between 950 HV10 and 1210 HV10, while the mean hardness was around 1095 HV10.

The cemented carbide hard facing was then heated at a temperature of around 1000° C. for around 20 minutes and subsequently quenched in oil to room temperature. The mean hardness of the resulting heat treated cemented carbide hard facing was found to be 1211 HV10, due to martensitic transformation, precipitation forming and grain boundary strengthening.

The micro-structure of the cemented carbide hard-facing at the interface between the steel substrate and the cemented carbide material before heat-treatment showed dendritic crystals of eta-phase FeₓW_{y}C with x in the range of 1 to 6 and y in the range of 1 to 6, angular WC, fibers of iron-chromium carbide and a binder based on Fe in the intermediate layer. This intermediate layer was around 200 μm thick.

The composition of the dendritic crystals as measured by Auger Electron Spectroscopy (AES) was 57 wt. % Fe, 29 wt. % W, 11 wt. % C and the remainder consisting of Cr and Si.

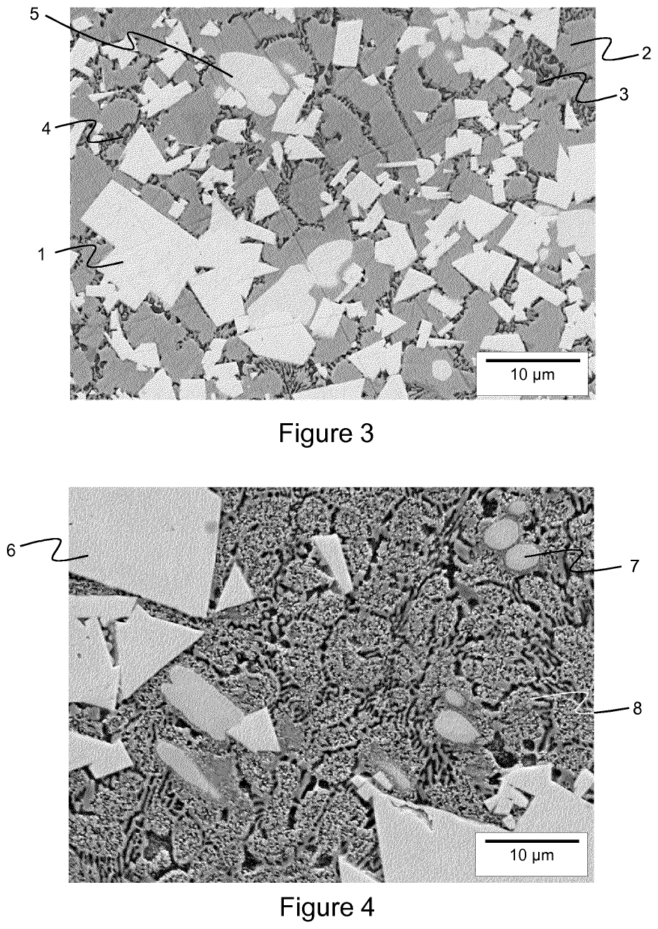

The microstructure shown in FIG. 3 of cemented carbide prior to heat treating shows angular WC 1 and two different binder phases 2, 3 based on iron, and shown in dark grey and black colour. The binder 2 shown in dark grey colour, referred to as the metastable binder phase, comprises around 62 wt. % Fe, around 22 wt. % W, around 10 wt. % Cr, around 2.5 wt. % Si and around 2.7 wt. % C. The metastable binder phase 2 is defined by nanohardness (performed at 30 mN) above 12 GPa, a microhardness of around 1050 HV0.02 and a Palmqvist fracture toughness of below 7 MPa m^{1/2}.

The dark grey fibres 4 which interconnect the dark grey binder phase 2 are an iron-chromium carbide, mainly of M₂₃C₆ stoichiometry, in which M is a combination of Fe, Cr and W. FIG. 3 also shows a phase of rounded particles of M₂C 5, with M being a combination of Fe, Cr and W.

The micro-structure of the heat-treated hard-facing structure illustrated in FIG. 4 shows coarse angular WC grains 6 and coarse rounded M₂C 7. The metastable phase as well as the oversaturated iron based binder, shown in black in FIG. 3, have reacted to the heat-treatment. The metastable binder phase 1 is transformed into nano scaled carbides 8 with varying sizes and some quantities of iron based binder phase. Some of the carbides are M₆C and M₂₃C₆, with M being either Fe, Co or Ni or an alloy thereof, stoichiometry. The black over-saturated binder phase shows precipitates of different carbide within the nano-scale after heat-treatment.

The coated and hardened steel substrate was tested by use of the ASTM G65-04 procedure A test to examine the wear resistance. Uncoated and coated substrates without heat-treatment were used as controls. The mass loss due to abrasion of the uncoated steel control was about 820 mg and about 63 mg for the coated substrate. The heat-treated and coated steel substrate had a mass loss of about 40 mg. The volume loss of the uncoated steel was 105.2 mm³ and that of the coated control sample was 5.9 mm³. The heat-treated coated substrate had a volume loss of 3.73 mm³. This indicates that the wear resistance of the heat-treated and coated steel described above is more than 20 times better than the uncoated steel and around 50% better as coated steel without heat-treatment.

### EXAMPLE 2

A 5 kg batch of powders comprising 72 wt. % WC powder with a mean diameter of about 0.8 μm, 15 wt. % Fe powder, 10 wt. % Cr₃C₂ powder and 3 wt. % Si powder was milled for around 24 hours in an attritor mill in a medium of hexane with 30 kg WC balls. The difference in starting composition from Example 1 is the Si content.

After milling the slurry was dried and the powder was screened to eliminate agglomerates. The resulting powder was pre-pressed to form blocks with a density suitable to allow handling for the subsequent manufacturing processes.

The blocks were then broken up by an Allgaiersieve to 500 μm and sieved to 260 μm. An ultra-sonic sieve was then used to screen the fine fraction below 75 μm of the granulate grains. The resulting granulate grains were pre-sintered at 1200° C. for one hour. The pre-sintered granulate grains were screened to 400 μm and 60 μm. The granulate fraction was then fully sintered at 1300° C. for 1.5 hours. Finally the fully sintered granulate grains were screened to 260 μm and 60 μm. Iron powder with the same grain fraction was then added to achieve 30 wt. % total iron content.

The resulting mixture was applied to four different provided steel substrates by plasma-transferred-arc welding. The PTA process used 150 Amps of transfer current, 30 grams per minute powder feed and a cladding speed of 44 millimetres per minute.

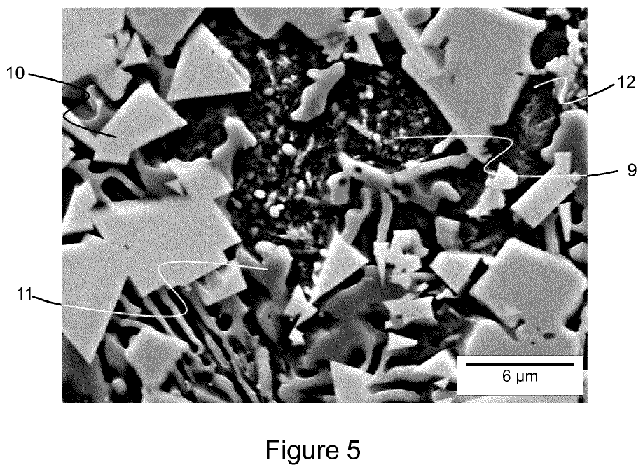

Hardness obtained by these parameters varied within the hard-facing between 916 HV10 and 1024 HV10, while the mean hardness was about 949 HV10. Three of the hard facings were exposed to temperatures of about 900° C., 950° C. and 1000° C. for around 20 minutes and quenched in oil to room temperature. The mean hardness was found to be 1045 HV10, 1084 HV10 and 1123 HV10 respectively due to martensitic transformation, precipitation forming and grain boundary strengthening. The differences in hardness between the presented heat-treatments derive from the varying energy which is being put into the system. The micro-structure of the sample heat-treated at 950° C. is shown in FIG. 5. The metastable binder phase has been transformed during the heat treatment into different sorts of nano-scaled carbides 9 including M₆C and M₂₃C₆, with M being either Fe, Co, Ni or a combination thereof and iron based binder. Furthermore coarser WC particles 10, coarser M₂₃C₆ particles 11 and an iron based binder 12 are shown.

### EXAMPLE 3

A 5 kg batch of powders comprising 72 wt. % WC powder with a mean diameter of about 0.8 μm, 15 wt. % Fe powder, 10 wt. % Cr₃C₂ powder and 3 wt. % Si powder was milled for about 24 hours in an attritor mill in a medium of hexane with 30 kg WC balls.

After milling, the resultant slurry was dried and the resultant powder was screened to eliminate agglomerates. The screened powder was pressed into blocks to achieve a density that allows handling in the subsequent manufacturing processes. The blocks were then broken up by an Allgaiersieve to 500 μm and sieved to 260 μm. An ultra-sonic sieve was then used to screen the fine fraction below 75 μm of the granulate grains. The resulting granulate grains were pre-sintered at 1200° C. for one hour.

The pre-sintered granulate grains were screened to 400 μm and 60 μm. The granulate fraction was then fully sintered at 1300° C. for 1.5 hours. Finally, the fully sintered granulate grains were screened to 260 μm and 60 μm. Iron powder with the same grain fraction was then added to achieve 35 weight percent total iron content.

The resulting mixture was applied to a steel substrate used in the construction industry. Relevant parameters of the welding process were 150 Amps of transfer current, 30 grams per minute powder feed and a cladding speed of 44 millimetres per minute. To enable the necessary cutting and deforming methods the coated steel was tempered at 820° C. for four hours. The mean hardness was found to be in the range of 725-770 HV10. After the required processing operations, the coated steel was hardened at 1030° C., with a holding time of 20 minutes and oil as a quenching medium. The obtained final hardness of the hard-facing was in the range of 993 HV10 to 1051 HV10 due to martensitic transformation, precipitation forming and grain boundary strengthening.

The cemented carbide as described herein may be used as part of a tool, such as a road or mining pick.

Various example embodiments of cemented carbides, methods for producing cemented carbides, and tools comprising cemented carbides have been described above. Those skilled in the art will understand that changes and modifications may be made to those examples without departing from the scope of the appended claims.

1. A method of producing a tool comprising a substrate and a hard-face coating metallurgically bonded to the substrate, the method comprising the steps of:
providing a steel substrate;
providing a composition of fully sintered granulate grains;
applying the fully sintered granulate grains onto the substrate;
the resultant cemented carbide material on the steel substrate comprising at least 0.1 wt. % Si, at least 5 wt. % Cr, less than 5 wt. % Mn, less than 10 wt. % Mo, at least 30 wt. % W, and the balance of the cemented carbide material comprising C and an iron group metal, M, M being selected from any of Co, Ni or an alloy thereof, the cemented carbide material further comprising inclusions of a metastable phase, the metastable phase comprising M, Cr, Si, W, and C, the metastable phase having a nanohardness of at least 12 GPa and a Palmqvist fracture toughness of below 7 MPa m^{1/2};
the method further comprising:
subsequently heat treating the cemented carbide material and substrate at a temperature of at least 700° C. to at least partial decomposition of the metastable phase, thereby producing a tool with a substrate and a hard-face coating metallurgically bonded to the substrate.

2. The method according to claim 1, further comprising performing a second heat treatment at temperature in the range of 300° C. to 700° C. for between 10 and 360 minutes.

3. The method according to claim 2, further comprising performing at least one further second heat treatment.

4. The method according to claim 1, further comprising quenching the heat treated cemented carbide material in any of water, oil, air, nitrogen, helium or a polymeric solution.

5. The method according to claim 1, further comprising cooling the cemented carbide material using at least one predetermined cooling rate.

6. The method according to claim 1, further comprising forming a carbide precipitate in a binder phase.

7. The method according to claim 6, wherein the carbide precipitate comprises any of M₂₃C₆, M₇C₃, M₃C₂, M₁₂C, M₆C, M₄C or M₃C₂.

8. The method according to claim 6, wherein the carbide precipitate has an average particle size selected from any of no more than 200 nm, and no more than 100 nm.

9. The method according to claim 1, further comprising forming any of Fe₃W₂ particles, FeSi particles, Cr₅Si₃ particles, and SiC particles during the heat treatment.

10. The method according to claim 1, wherein the hard-face coating has a Vickers hardness selected from any of at least 800 HV10, at least 900 HV10 and at least 1000 HV10.

11. The method according to claim 1, further comprising forming nano-precipitates of mixed (Cr, M)₂₃C₆.

12. The method according to claim 1, further comprising forming nano-precipitates of at least one phase of the W—Fe—C system.

13. The method according to claim 1, further comprising forming a nano-structured Fe-based binder matrix with a ferritic, austenitic or martensitic structure having mean grain size selected from any of below 50 nm, below 30 nm and below 20 nm.

14. The method according to claim 1, wherein the step of applying the fully sintered granulate grains onto the steel substrate comprises a high temperature plasma spraying operation.

15. The method according to claim 1, wherein the metastable phase comprises 50 wt. % to 70 wt. % M, 5 wt. % to 15 wt. % Cr, less than 10 wt. % Si, 10 to 40 wt. % W and 1 to 5 wt. % C.

16. The method according to claim 1, wherein the metastable phase comprises 55 wt. % to 65 wt. % M, 5 wt. % to 15 wt. % Cr, less than 7 wt. % Si, 15 wt. % to 30 wt. % W and 2 wt. % to 4 wt. % C.

17. The method according to claim 1, wherein the metastable phase comprises 50 wt. % to 70 wt. % M, 5 wt. % to 15 wt. % Cr, less than 10 wt. % Si, 15 wt. % to 30 wt. % W, 2 wt. % to 4 wt. % C, less than 5 wt. % Mn, and less than 10 wt. % Mo.

18. The method according to claim 1, wherein the metastable phase has a cubic lattice structure.

19. The method according to claim 1, wherein the metastable phase has a hexagonal lattice structure.

20. The method according to claim 1, wherein the metastable phase has a tetragonal lattice structure.

21. (canceled)

22. (canceled)
